(19) United States
(12) Patent Application Publication
(10) Pub. No.: US 2025/0225265 A1
(43) Pub. Date: Jul. 10, 2025

(54) DEVICE AND METHOD FOR PROVIDING SECURITY FOR DEX FILE PROTECTION AND DEVICE AND METHOD FOR EXECUTING SECURITY

(71) Applicant: INKA ENTWORKS, INC., Seoul (KR)

(72) Inventors: Seong-Jo LEE, Goyang-si, Gyeonggi-do (KR); Jung-Geun PARK, Seoul (KR); Jung-Soo KIM, Yongin-si, Gyeonggi-do (KR)

(21) Appl. No.: 18/852,851

(22) PCT Filed: Mar. 30, 2023
(86) PCT No.: PCT/KR2023/004309

§ 371 Date: Sep. 30, 2024

(30) Foreign Application Priority Data
Apr. 1, 2022 (KR) 10-2022-0040860

(51) Int. Cl. G06F 21/62

(52) U.S. Cl. CPC G06F 21/6218

(57) ABSTRACT

The present invention relates to a device and method for providing security, and a device and method for executing security that can protect DEX files from hacking and reduce the time required to execute an app. Specifically, the security providing method for protecting a DEX file of the invention, comprises the steps of; extracting a DEX file from an app received from a program developing device; compiling said extracted DEX file into a machine language DEX file; protecting said compiled machine language DEX file; generating a replacement DEX file capable of executing said protected machine language DEX file; and packaging said protected machine language DEX file, said generated replacement DEX file, and associated ELF files into an app.

### FIELD OF THE INVENTION

The present invention relates to a device and method for providing security, and a device and method for executing security for a Dalvik Executable (DEX) file Protection. More specifically, it relates to a device and method for providing security, and a device and method for executing security that can protect DEX files from hacking and reduce the time required to execute an app.

### BACKGROUND

A user terminal device, including an Android operating system, may have its own virtual machine, such as Dalvik. A program running on such a user terminal device is coded by a programmer in Java or Kotlin and is first compiled into the state of an intermediate language, e.g., Bytecode, to create a DEX file. Other files related to the execution of the program are added to the created DEX file, which is then packaged and distributed as an application (hereafter referred to as an “APP”). A structure of a typical APK (or an Original APK (Android application package)) is shown in the left side of FIG. 1.

The executable code in the DEX file of a deployed app (APK or AAB) can be secondarily compiled by the Android operating system to be adapted for the program execution environment of the user terminal when it is installed on the user terminal. During the secondary compilation process, an OAT file is generated that consists of machine language optimized for each Android device.

However, DEX files running on the Android operating system are implemented based on widely known bytecodes, so they are vulnerable to vulnerability analysis or code tampering through reverse engineering. In order to protect DEX files, which are bytecodes, from reverse engineering, a packer service that encrypts the entire DEX file is provided. For this packer service, please refer to the paper “Original app exposure prevention technique by changing Android Dex class loader execution flow” (Journal of the Information Security Society Vol. 27, No. 6, pages 1271-1280).

The structure of an APK (APK) protected by applying the packer service disclosed in the above paper is shown on the right side of FIG. 1. In the protected APK, the original DEX file is stored separately in an encrypted state (Encrypted Original DEX), and a new DEX file and ELF (Executable and Linkable Format) file are added respectively (Added DEX, Added ELF). Additionally, the manifest is modified to convert the app's startup flow to the added DEX file.

However, APKs protected by the packer service take a significant amount of time to compile the DEX file into an OAT file on first launch on the Android operating system. This is because the encrypted DEX file cannot be compiled into an OAT file by the AOT (Ahead-of-Time) compiler when the app is installed (because it is encrypted). On the other hand, in order to reduce the time required to compile DEX files into OAT files, lowering the DEX code optimization level during OAT file generation can lead to a decrease in the app's execution speed.

In addition, when running an APK protected by a packer service on the Android operating system, during the encrypted DEX file is decrypted, the entire decrypted DEX file (i.e., the original DEX file) may be loaded into memory. Therefore, if the entire memory is dumped while the program is running and then reverse engineered, the program code of the original DEX file may be exposed.

### SUMMARY

It is a purpose of the present invention to provide a security providing device and method and a security executing device and method, wherein DEX files are protected from hacking, the loading time of DEX files is minimized when executing an app, and the DEX file is compiled in machine language in advance to avoid slowing down the execution of the app.

It is a purpose of the present invention to provide a security providing device and method and a security executing device and method, wherein, to protect DEX files from hacking, the compiled DEX file is encrypted for each method separately one-by-one, and only the necessary methods are decrypted at the time of execution, and the decrypted methods are distributed in memory.

According to an embodiment, a security providing method for protecting a DEX file, the method may comprise the steps of: extracting a DEX file from an app received from a program developing device; compiling said extracted DEX file into a machine language DEX file; protecting said compiled machine language DEX file; generating a replacement DEX file capable of executing said protected machine language DEX file; and packaging said protected machine language DEX file, said generated replacement DEX file, and associated ELF files into an app.

According to a further embodiment, said step of compiling can comprise compiling said extracted DEX file into an OAT file by an AOT (Ahead-of-Time) compiler.

According to a further embodiment, the step of protecting can comprise parsing said compiled machine language DEX file to extract methods to be encrypted and performing encryption for the extracted methods on a method-by-method basis.

According to a further embodiment, the generated replacement DEX file can be filled with dummy information or proxy information in each method of the generated replacement DEX file.

According to another embodiment, a security executing method performed on a security executing device having an app packaged by the security providing method and stored in a storage unit may comprise the steps of: installing said packaged app; when execution of said installed app is requested, loading a corresponding replacement DEX file from said storage unit into the memory unit; and when a predetermined method is called, finding and executing the corresponding method from a protected machine language DEX file in said replacement DEX file.

According to a further embodiment, the step of installing can comprise compiling said replacement DEX file into a replacement machine language DEX file, optimized for the execution environment of said security executing device in which said app is to be executed, and the step of loading can comprise loading said compiled replacement machine language DEX file from said storage unit into said memory unit.

According to a further embodiment, the replacement machine language DEX file can be compiled by the AOT (Ahead-of-Time) compiler.

According to a further embodiment, said protected machine language DEX file of said packaged app can be encrypted for each method by way of a method-by-method basis, and the step of executing can comprise, when a predetermined method is first called, finding said method in said encrypted machine language DEX file in said storage unit, loading said method into said memory unit, and decrypting said method of said encrypted machine language DEX file in said memory unit.

According to a further embodiment, the step of executing can comprise decrypting the said method in said encrypted machine language DEX file, and subsequently distributing the decrypted method by storing said decrypted method in a location different from the location of the encrypted method in said memory unit.

According to a further embodiment, said step of loading can comprise building a trampoline scheme using said compiled replacement machine language DEX file and ELF file, and said step of executing can comprise, when a predetermined method is called, accessing a location of said method in said encrypted machine language DEX file by said constructed trampoline scheme.

According to a further embodiment, the compiled replacement machine language DEX file can contain proxy information for each method, and the step of executing can comprise, when the predetermined method is called, accessing the location of the method in the encrypted machine language DEX file using the proxy information for the method.

According to the further embodiment, a security providing device for protecting a DEX file may comprise: at least one processor configured to execute computer-readable instructions stored on the storage unit. Wherein the at least one processor may be configured for: extracting a DEX file from an app received from a program developing device, compiling said extracted DEX file into a machine language DEX file, protecting said compiled machine language DEX file, generating a replacement DEX file capable of executing said protected machine language DEX file, and packaging said protected machine language DEX file, said generated replacement DEX file, and associated ELF files into an app.

According to a further embodiment, the processor can be configured to parse the compiled machine language DEX file to extract the methods to be encrypted, and to perform encryption for the extracted methods on a method-by-method basis.

According to a further embodiment, in the said generated replacement DEX file, each method of the said replacement DEX file can be filled with dummy information or proxy information.

According to yet another embodiment, a security executing device storing the app packaged by the security providing device in a storage unit may include at least one processor configured to execute the computer-readable instructions stored on said storage unit, wherein said at least one processor may be configured for: installing said packaged app, when an execution of said installed app is requested, loading a replacement DEX file from said storage unit into said memory unit; and when a predetermined method is called, finding said method of the protected machine language DEX file in said replacement DEX file and executing it.

According to a further embodiment, said processor can be configured for compiling said replacement DEX file into a replacement machine language DEX file adapted to the execution environment of said security executing device in which said app is to be executed, and storing said replacement machine language DEX file in said storage unit, and when execution of said installed app is requested, loading said compiled replacement machine language DEX file from said storage unit into said memory unit.

According to a further embodiment, said protected machine language DEX file of said packaged app can be encrypted on a method-by-method basis, and, said processor can be configured for, when a predetermined method is called, locating said method of said encrypted machine language DEX file in said storage unit, loading said method into said memory unit, and decrypting said method of said encrypted machine language DEX file in said memory unit.

According to a further embodiment, said processor can be configured for decrypting said method of said encrypted machine language DEX file and storing said decrypted method in a location different from the location of the encrypted method in said memory unit, thereby distributing the decrypted method.

By compiling a DEX file into a pre-optimized OAT file during the process of packaging a security app, the present invention can eliminate the optimization time of the original DEX file when the app is executed, thereby minimizing the impact of loading time and preventing the app from running slower.

Furthermore, the present invention can address security concerns that arise when a DEX file implemented as bytecode is loaded in its entirety into memory. In particular, by decrypting the portions of the DEX file required for execution into random locations in memory, the entire DEX file can be prevented from being stolen by a memory dump.

Furthermore, the present invention can provide security for each method, by encrypting and protecting each method stored in a DEX file on a method-by-method basis. Furthermore, by decrypting only methods which are requested during executing the app into memory, it is possible to prevent the entire method from being stolen.

### BRIEF DESCRIPTION OF THE DRAWINGS

FIG. 1 is a diagram illustrating a structure of a typical APK and a structure of a APK protected by applying a packer service.

FIG. 2 is a diagram illustrating a configuration of a security system for protecting a DEX file in accordance with an embodiment of the present invention.

FIG. 3 is a block diagram to illustrate the case that the program developing device, the security providing device, or the user terminal device shown in FIG. 2 operates as a general computing device.

FIG. 4 is a diagram illustrating a block diagram of the security providing device shown in FIG. 2.

FIG. 5 is a diagram to illustrate the operation of the security providing device shown in FIG. 4 during an AOT compiler is used to optimize a security app.

FIG. 6 is a diagram illustrating a block diagram of the user terminal device shown in FIG. 2.

FIG. 7 is a diagram illustrating a flowchart to illustrate the operation for executing an app file provided in accordance with the embodiment of Fig. n terminal device illustrated in FIG. 6.

FIG. 8 is a diagram specifically illustrating a process and way of memory management for operating an app during runtime according to the embodiment of FIG. 7.

FIG. 9 is a diagram illustrating another embodiment to illustrate a flow of operations for executing an app file provided in accordance with the embodiment of FIG. 5 on the user terminal device shown in FIG. 6.

FIG. 10 is a diagram specifically illustrating a process and way of memory management for operating an app during runtime according to the embodiment of FIG. 9.

FIG. 11 is a flowchart illustrating a security providing method for securing a DEX file according to one embodiment of the present invention.

FIG. 12 is a flow diagram of a security executing method for securing a DEX file, according to another embodiment of the present invention.

### DETAILED DESCRIPTION

Hereinafter, with reference to the accompanying drawings, preferred embodiments of a security providing device and method and a security executing device and method for protecting DEX files according to the present invention will be described. It should be noted that the terms referring to each component of the present invention are named exemplarily in view of its function and should not be understood as predicting or limiting the technical content of the present invention by the terms themselves.

Furthermore, the various embodiments of the invention described herein are intended only to exemplify the technical ideas of the invention, and the scope of protection of the invention should be construed in accordance with the appended claims. Furthermore, a person skilled in the technical field to which the present invention belongs will be able to design various modifications and variations without departing from the essential features of the invention. Therefore, the scope of the present invention should be interpreted as covering all technical ideas that are equally within the scope of the present invention.

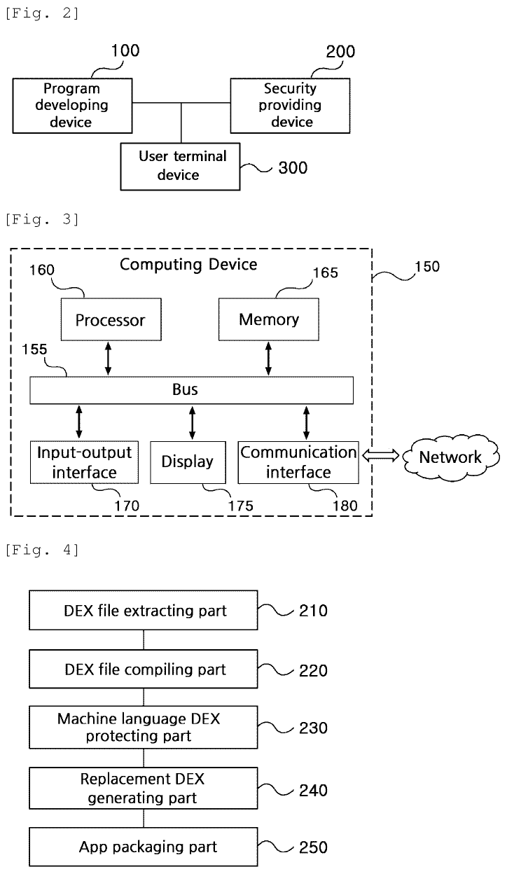

FIG. 2 is a drawing illustrating a configuration of a security system for securing a DEX file according to one embodiment of the present invention. As shown, a security system for securing a DEX file according to one embodiment of the present invention includes a program developing device 100, a security providing device 200, and a user terminal device 300.

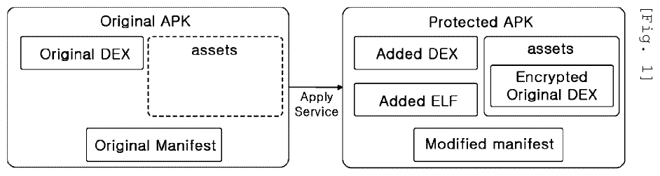

The program developing device 100 is a device for a developer to develop an app program. When an app program is developed to be executed by a virtual machine such as Dalvik, the Java code of the app program is converted to a .class file, which is bytecode, by a Java compiler. The converted .class file is then built into a .dex file to be executed by Dalvik. The built .dex file is packaged into one app file, along with resource files that contain the images, sounds, metadata, etc. that make up an app. This app file, the APK, is shown in FIG. 1 on the left as a structure of a typical APK. The resource files are located in the res and assets folders.

The security providing device 200, upon receiving an APK generated by the program developing device 100, i.e., for example when the APK is uploaded, parses the original DEX file from the APK, compiles the original DEX file into a machine language DEX file in order to pre-optimize it for the various execution environments (architectures or operating systems) in which the original DEX file will be executed, and encrypts the machine language DEX file. The encrypted machine language DEX file is packaged together with the ELF file which is an executable file into an app file.

A user terminal device 300 is a device in which an app program, such as a game app, executes. The user terminal device 300 may download the packaged app file, e.g., the game app, from the program developing device 100 or the security providing device 200 and install it to execute the game program. The user terminal device 300 is, in other words, a security executing device.

The user terminal device 300 according to an embodiment of the present invention is a terminal device equipped with an Android operating system. The user terminal device 300 according to an embodiment of the present invention may be a server terminal device including an application server, a service server, and the like. The user terminal device 300 according to an embodiment of the present invention may refer to a variety of devices having (i) a communication device such as a communication modem for communicating with various devices or wired or wireless communication networks, (ii) a memory for storing data for executing a program, (iii) a microprocessor for executing a program to perform operations and controls, and the like.

In FIG. 2, for example, the program developing device 100 and the security providing device 200 are illustrated as separate devices, but are not limited thereto. Further, the program developing device 100, the security providing device 200, and the user terminal device 300 may be connected to each other via a wired or wireless communication network.

FIG. 3 is a block diagram illustrating a case that a program developing device, a security providing device, or a user terminal device shown in FIG. 2 operates as a general computing device.

As shown in FIG. 3, a computing device 150 connected with a network may include a bus 155, a processor 160, a memory 165, an input/output interface 170, a display 175, and a communication interface 180. In some embodiments, the computing device 150 may omit at least one of the components or may have additional components.

The bus 155 may include circuitry that connects the components 160-180 to each other and carries communication (e.g., commands, code, messages, or data) between the components 160-180.

The processor 160 may be configured to process instructions from a computer program by performing basic arithmetic, logic, and input/output operations. The processor 160 may include one or more of a central processing unit, an application processor, or a communication processor (CP).

The memory 165 may include volatile and/or non-volatile memory. The memory 165 may include a permanent mass storage device, such as random access memory (RAM), read only memory (ROM), disk drive, solid state drive (SSD), flash memory, or the like, and a non-transitory mass storage device, such as ROM, SSD, flash memory, disk drive, or the like.

The memory 165 may store an operating system and at least one program code (e.g., code for a browser installed and running on the electronic device 110 or an application installed on the electronic device 110 to provide a particular service). These software components may be loaded from a computer-readable recording medium that is separate from the memory 165. Such a separate computer-readable recording medium may include a computer-readable recording medium such as a floppy drive, disk, tape, DVD/CD-ROM drive, memory card, or the like. In other embodiments, software components may be loaded into memory 165 via communication interface 180 rather than a computer-readable recording medium.

The input/output interface 170 may, for example, pass commands or data input from a user or other external device to other component(s) of the computing device 150, or output commands or data received from other component(s) of the computing device 150 to a user or other external device.

The display 175 may include, for example, a liquid crystal display (LCD), a light-emitting diode (LED) display, an organic light-emitting diode (OLED) display, a microelectromechanical system (MEMS) display, or an electronic paper display. The display 175 can, for example, display various content (e.g., text, images, video, icons, and/or symbols) to a user. The display 175 may include a touch screen and may receive touch, gesture, proximity, or hovering input, for example, via an electronic pen or a part of the user's body.

The communication interface 180 may establish communication with, for example, another computing device (not shown). For example, the communication interface 180 may be connected to the network 130 via wireless communication or wired communication to communicate with other devices. computing The wireless communication may include, for example, cellular communication using at least one of LTE, LTE Advance (LTE-A), code division multiple access (CDMA), wideband CDMA (WCDMA), universal mobile telecommunications system (UMTS), wireless broadband (WiBro), or global system for mobile communications (GSM). In one embodiment, the wireless communication may include at least one of, for example, wireless fidelity (WiFi), Bluetooth, Bluetooth low energy (BLE), Zigbee, near field communication (NFC), magnetic secure transmission, radio frequency (RF), or body area network 130 (BAN). In one embodiment, the wireless communication may include GNSS. The GNSS may be, for example, the Global Positioning System (GPS), the Global Navigation Satellite System (Glonass), the Beidou Navigation Satellite System (“Beidou”), or Galileo, the European global satellite-based navigation system. Hereinafter, in this document, “GPS” may be used interchangeably with “GNSS”. The wired communication may include at least one of, for example, USB (universal serial HDMI bus), (high definition multimedia interface), RS-232 (recommended standard232), power line communication, or POTS (plain old telephone service).

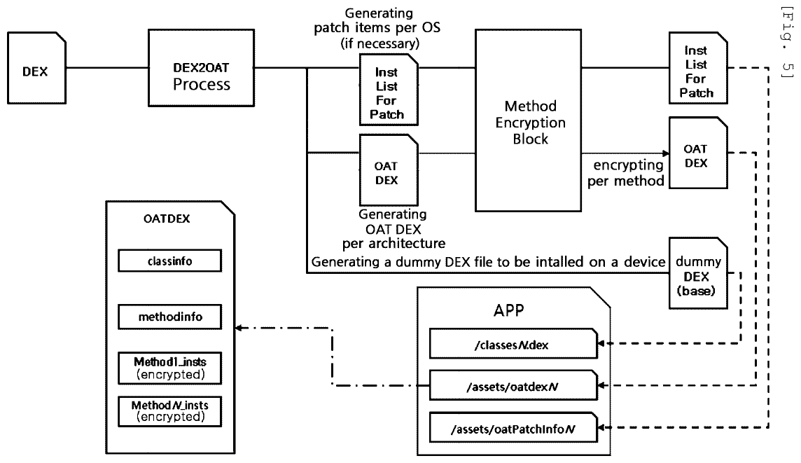

FIG. 4 is a diagram illustrating a block diagram of the security providing device shown in FIG. 2.

As shown in FIG. 4, the processor 160 of the security providing device 200 may be operable to perform as functions of a DEX file extraction part 210, a DEX file compilation part 220, a machine language DEX protecting part 230, a replacement DEX generation part 240, and an app packaging part 250.

The DEX file extraction part 210 may parse an app file received from the program developing device 100, such as an uploaded app file, to extract an original DEX file.

The DEX file compilation part 220 compiles the original DEX file into a machine language DEX file in order to pre-optimize the original DEX file for the various execution environments (architectures or operating systems) in which the original DEX file will be executed. The program execution environments may include armeabi-v7a, arm64-v8a, x86, x86_64, and the like, and a particular execution environment may be selected by the manufacturer of the user terminal device 300 and installed on the user terminal device 300.

Specifically, the DEX file compiling part 220 can compile the extracted original DEX file into an OAT file by an AOT (Ahead-of-Time) compiler. In this case, the AOT compiler may generate OAT files for different execution environments of the app, corresponding to each execution environment. On the other hand, the DEX file compiling part 220 may also compile the original DEX file into an odex file (hereinafter referred to as a compiled machine language DEX file).

The machine language DEX protecting part 230 encrypts the compiled machine language DEX file to protect the compiled machine language DEX Specifically, language file. the machine DEX protecting part 230 may parse the compiled machine language DEX file to extract each method and perform encryption for each extracted method. However, for convenience, embodiments of the present invention will focus on techniques where the compiled machine language DEX file is separated into methods and encrypted separately for each method one-by-one. The encrypted machine language DEX file is then decrypted and ready for immediate execution on the user terminal device 300, without any further optimization. While this embodiment focuses on encryption, the machine language DEX protecting part 230 may apply code obfuscation to protect the compiled machine language DEX file.

The replacement DEX generating part 240 generates and configures a replacement DEX file for replacing the original DEX file. The replacement DEX generating part 240 may configure the replacement DEX file by filling each method of the replacement DEX file with dummy information or proxy information.

The app packaging part 250 repackages the encrypted machine language DEX file and the ELF file generated by the machine language DEX protecting part 230, the replacement DEX file the ELF file and other related resources generated by the replacement DEX generating part 240 into a single app file, to create a security app file. Here, the ELF file is an executable file for executing the encrypted machine language DEX file and the replacement DEX file.

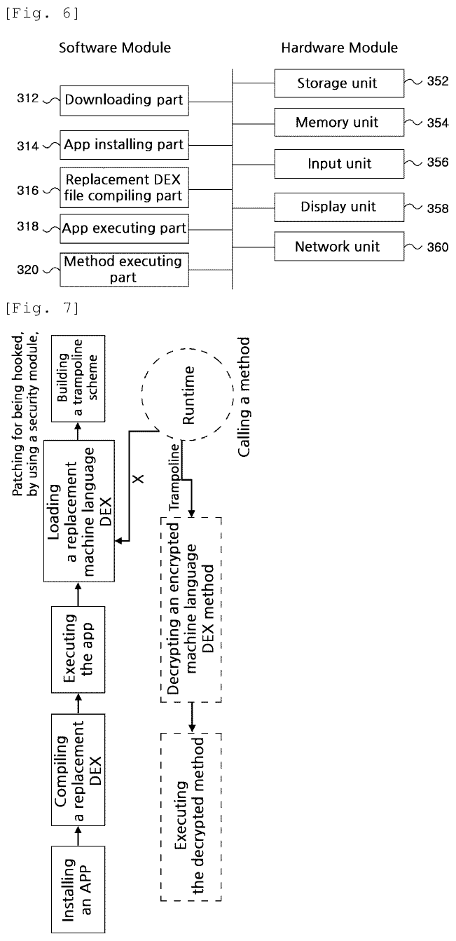

FIG. 5 is a diagram to illustrate the operation of the security providing device shown in FIG. 4, when the AOT compiler is used to optimize the security app. The DEX file extracting part 210 parses the uploaded app file from the program developing device 100 to extract the original DEX file.

The DEX file compiling part 220 includes a dex2oat process. The dex2oat process compiles the original DEX file by the AOT compiler to form an OAT file in order to pre-optimize the original DEX file for various execution environments in which the original DEX file will be executed. The dex2oat process may, for example, convert the code contained in the original DEX file into native code. In addition, in the security providing device 200, operating system-specific patch items may be added on it.

The machine language DEX protecting part 230 may include a method encryption block. The method encryption block can individually encrypt each of the methods included in the machine language DEX file, and can also encrypt architecture-specific patch information.

The replacement DEX generating part 240 can construct a replacement DEX file that includes dummy information or proxy information, by means of replacing the contents of each method constructing the original DEX file with a dummy value that is a meaningless value, or with a proxy that calls an ELF library configured to execute the encrypted machine language DEX. The replacement DEX file can still be recognized by the operating system as the original DEX file because only the contents of the methods in the original DEX file have been changed.

The app packaging part 250 may package the encrypted patch information, the encrypted machine language DEX file, and the replacement DEX file together into a single app file to form a security app.

The packaged security app can then be provided to the program developing device 100 in order for being delivered as an app file to the user terminal device 300.

FIG. 6 is a drawing illustrating a block diagram of the user terminal device shown in FIG. 2.

As shown in FIG. 6, the user terminal device 300 includes a software module and a hardware module.

The software module is operated by the processor 160 and may include a downloading part 312, an app installation part 314, a replacement DEX file compiling part 316, an app execution part 318, and a method execution part 320. The hardware module may include a storage unit 352, a memory unit 354, an input unit 356, a display unit 358, and a network unit 360.

The downloading part 312, in communication with the program developing device 100 or the security providing device 200 via the network unit 360, downloads the security app and stores it in the storage unit 352.

The app installing part 314 operates the security app stored in the storage unit 352 and installs the app.

The replacement DEX file compiling part 316 compiles the replacement DEX file to construct a replacement machine language DEX file in order to optimize the replacement DEX file for the execution environment of the user terminal device 300 in which the replacement DEX file is to be executed. Specifically, the replacement DEX file compiling part 316 may compile the replacement DEX file by an AOT (Ahead-of-Time) compiler to construct the OAT file. In this case, the AOT compiler may generate an OAT file adapted for each execution environment in response to different execution environments of the program.

The replacement DEX file, however, is reconstructed from the first original DEX file, with only the contents of the methods replaced with dummy information. Therefore, the operating system will recognize the replacement DEX file as if it were the existing DEX file, i.e., the original DEX file. On the other hand, optimization of the replacement DEX file (i.e., generation of a compiled replacement machine language DEX file) can be completed quickly because the contents of the methods in the replacement DEX file may be meaningless dummy information and the amount of the data may be minimized.

The app executing part 318 loads the replacement machine language DEX file compiled by the replacement DEX file compiling part 316 and the ELF file into the memory unit 354 when the app execution is requested by the input unit 356. The app executing part 318 can build the Trampoline scheme using the loaded replacement machine language DEX file and the ELF file. The app executing part 318 may also load a pre-optimized and encrypted machine language DEX file from the security providing device 200 into a specific location in the memory unit 354. Thereby, the app is ready to be executed.

The method executing part 320 may include a decryption part to decrypt the encrypted machine language DEX file loaded from the app executing part 318. Then, when a predetermined method is called, the corresponding method of the decrypted machine language DEX file can be accessed by using the compiled alternative machine language DEX file and ELF file. The method executing part 320 may, if the encrypted machine language DEX file is encrypted on a method-by-method basis, decrypt only the corresponding method called from the encrypted machine language DEX file when the predetermined method is called, and store the decrypted method in a random location in the memory unit 354, i.e., a location different from where the encrypted method has been stored.

The method executing part 320 may execute the decrypted methods and, for example, display the results of the execution on the display unit 358.

With this execution method, even if (a hacker) obtains the contents of the replacement DEX file by memory dump, the original DEX file is protected because the contents of the obtained replacement DEX file are only dummy information. Also, all methods in the DEX file are not decrypted and loaded into memory all at once, so the contents of the methods can be protected. Also, when the app is executed, the pre-compiled machine language DEX file is loaded and executed, so it does not slow down the speed of app execution.

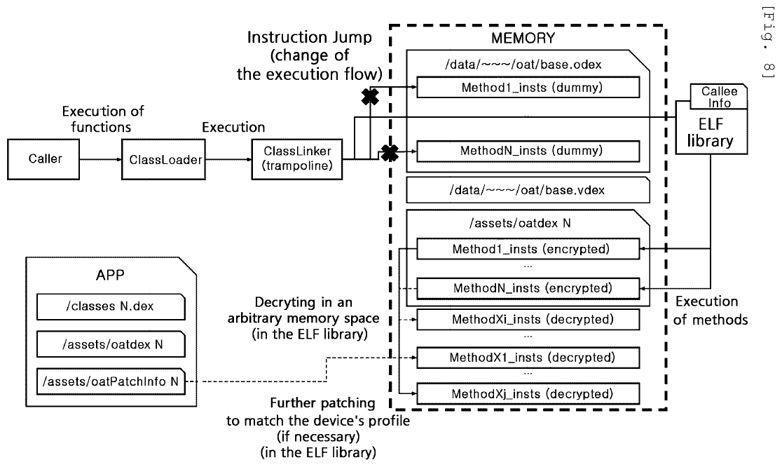

FIG. 7 is a diagram illustrating one embodiment to describe a flow of operations for executing an app file provided in accordance with the embodiment of FIG. 5 in the user terminal device shown in FIG. 6.

The app installing part (314) installs the app by executing the security app stored in the storage unit (352).

The replacement DEX file compiling part 316 compiles the replacement DEX file to construct a replacement machine language DEX file in order to optimize the replacement DEX file for the execution environment of the user terminal device 300 in which the replacement DEX is to be executed. file Specifically, the replacement DEX file compiling part 316 may compile the replacement DEX file by an AOT (ahead-of-time) compiler to construct the OAT file. In this case, the AOT compiler may generate an OAT file that is tailored to the execution environment of the user terminal device 300.

The app executing part 318 loads the replacement machine language DEX file compiled by the replacement DEX file compiling part 316 and the ELF file into the memory unit 354 when the app execution is requested by the input unit 356. The app executing part 318 can build a trampoline scheme using the loaded replacement machine language DEX file and the ELF file. The app executing part 318 may also load a pre-optimized and encrypted machine language DEX file from the security providing device 200 into a specific location in the memory unit 354.

If the encrypted machine language DEX file is encrypted on a per-method basis, the method executing part 320 may, when a predetermined method is called, decrypt the method from the encrypted machine language DEX file using a trampoline scheme, and then store the decrypted method in a random location in the memory unit 354, i.e., a location different from where the encrypted method was loaded. The method executing part 320 may then execute the decrypted method and, for example, display the execution result on the display unit 358.

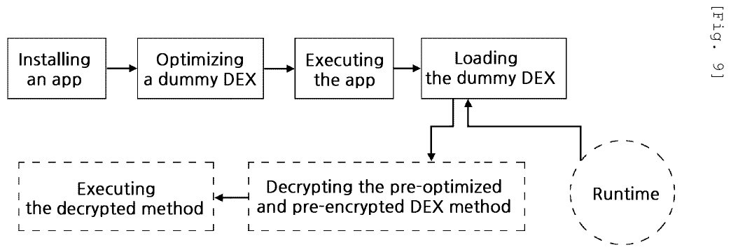

FIG. 8 is a diagram further illustrating a process of executing an app and a way of memory management, during runtime, in accordance with the embodiment of FIG. 7.

The app executing part 318 loads the replacement machine language DEX file compiled by the replacement DEX file compiling part 316 into the memory unit 354 when the app execution is requested by the input unit 356. The ELF file may also be loaded at this time. The replacement machine language DEX file loaded into the memory unit 354 is labeled “/data/˜˜˜/oat/base.odex”. Then, the app executing part 318 can build a trampoline scheme using the loaded replacement machine language DEX file. The constructed trampoline scheme is labeled as ClassLinker (trampoline). The app executing part 318 also loads the encrypted machine language DEX file, pre-optimized in the security providing device 200, into a specific location in the memory unit 354. The encrypted machine language DEX file loaded into memory unit 354 is denoted as “/assets/oatdexN”.

When the method executing part 320 makes a call to a specific method to execute a specific function, the caller first sends a request for resolving a class containing the functions to the ClassLoader in order to execute the method, i.e., the functions contained in the class. The ClassLoader makes the ClassLinker to resolve the class containing the functions. The ClassLinker changes the flow of execution by hooking it according to the built-in trampoline scheme, thereby an instruction jump into the ELF library is occurred.

The ELF library reads out the location of the class's calling function from Callee info and accesses the encrypted method code area which is in the form of a native code and is pre-compiled. The decryption part decrypts the encrypted method code and stores the decrypted method code in any other area of the memory unit 354. Meanwhile, the replacement DEX file or ELF file may be further patched to suit the user terminal device as needed. The method executing part 320 executes the decrypted method code. The decrypted method code may remain in the memory unit 354 after the method execution.

The method executing part 320 may selectively decrypt only the specific methods that are needed, thereby avoiding a situation where all methods are stored in a decrypted state in the memory unit 354 at once. In particular, the method executing part 320 may decrypt certain methods and then store the decrypted methods in a location that is randomly spaced from or unrelated to the location of previously decrypted and loaded methods, thereby distributing the decrypted methods among themselves.

FIG. 9 is diagram depicting another embodiment to a illustrate a flow of operations for executing an app file provided in accordance with the embodiment of FIG. 5 on the user terminal device shown in FIG. 6.

The app installing part (314) installs the app by executing the security app stored in the storage unit (352).

The replacement DEX file compiling part (316) compiles the replacement DEX file into a replacement machine language DEX file in order to optimize the replacement DEX file for the execution environment of the user terminal device (300) in which it will be executed. Specifically, the replacement DEX file compiling part 316 may compile the replacement DEX file into an OAT file by an Ahead-of-Time (AOT) compiler. In this case, the AOT compiler may generate the OAT file to correspond to the execution environment of the user terminal device 300.

The app executing part 318 loads a replacement machine language DEX file compiled by the replacement DEX file compiling part 316 into the memory unit 354 when the app execution is requested by the input unit 356. Each method of the replacement machine language DEX file loaded into memory contains proxy information that calls an ELF library configured to execute the encrypted machine language DEX. The app executing part 318 may also load a machine language DEX file that has been pre-optimized and encrypted by the security providing device 200 into a specific location in the memory unit 354.

In case that the encrypted machine language DEX file is encrypted on a method-by-method basis, when a particular method is invoked, the method executing part 320 accesses the location of the corresponding method in the encrypted machine language DEX file, using proxy information stored as the content of the corresponding method in the replacement machine language DEX file and under the control of the ELF library, decrypts the corresponding method, and stores the decrypted method in a random location in the memory unit 354, i.e., a location different from where the encrypted method was loaded. The method executing part 320 may then execute the decrypted method and, for example, display the results of the execution on the display unit 358.

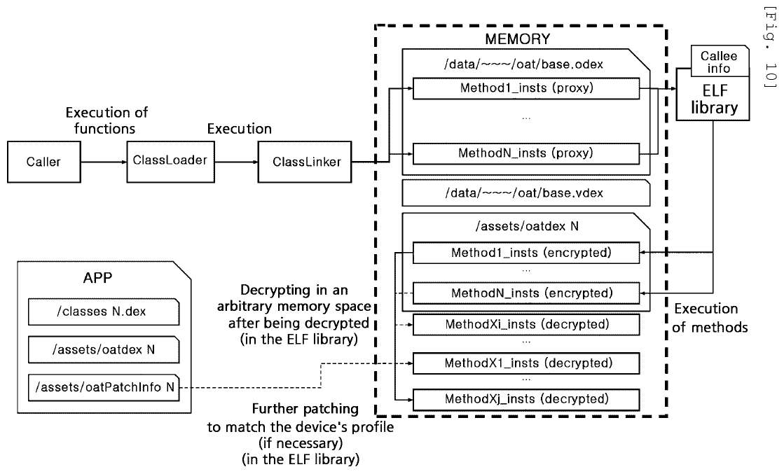

FIG. 10 is a diagram specifically illustrating a process and a way of memory management for executing an app during runtime according to the embodiment of FIG. 9.

The app executing part 318 loads the replacement machine language DEX file compiled by the replacement DEX file compiling part 316 into the memory unit 354 when the app execution is requested by the input unit 356. The replacement machine language DEX file loaded into memory unit 354 is labeled “/data/˜˜˜/oat/base.odex”. Each method contains proxy information.

The app executing part 318 also loads a machine language DEX file that has been pre-optimized and encrypted by the security providing device 200 into a specific location on the memory unit 354. The encrypted machine language DEX file loaded into the memory unit 354 is denoted as “/assets/oatdexN”.

When the method executing part 320 calls a specific method to execute a specific function, the caller first sends a request for resolving the class containing the function to the ClassLoader, in order to execute the method, i.e., the function contained in the class. The ClassLoader causes the ClassLinker to resolve the class containing the function. The ClassLinker calls the target method of the alternate DEX and the execution switches to the ELF library via the method's proxy code.

The ELF library uses the proxy information to read out the location of the corresponding class's calling function from Callee info and accesses into the encrypted method code region which is in the form of a native code and is pre-compiled. The decryption part decrypts the encrypted method code and stores the decrypted method code in any other area of the memory unit 354. Meanwhile, the ELF library performs additional patches appropriate for the user terminal device 300 as needed. The method executing part 320 executes the decrypted method code. The decrypted method code may remain in the memory unit 354 after the method execution.

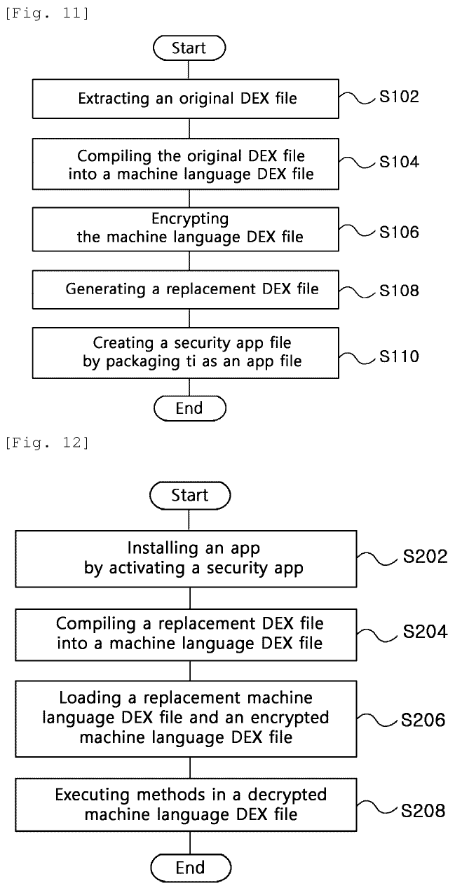

FIG. 11 is a flow diagram illustrating a security providing method for securing a DEX file according to one embodiment of the present invention.

The DEX file extracting part 210 parses the APK uploaded from the program developing device 100 to extract the original DEX file (S102).

The DEX file compiling part 220 compiles the original DEX file into a machine language DEX file to pre-optimize the original DEX file for various execution environments in which the original DEX file will be executed (S104).

The machine language DEX protecting part (230) encrypts the machine language DEX file compiled by the DEX file compiling part (220) to protect the machine language DEX file (S106). The machine language DEX protecting part 230 may parse the compiled machine language DEX file to extract methods to be encrypted and encrypt the extracted methods individually.

The replacement DEX generating part 240 generates a replacement DEX file for replacing the original DEX file (S108).

The app packaging part (250) repackages the replacement DEX file generated by the replacement DEX generating part (240), the encrypted machine language DEX file generated by the machine language DEX protecting part (230), the ELF file, and other related resources into a single app file to create a security app file (S110). Here, the ELF file is an executable file for executing the replacement DEX file and the encrypted machine language DEX file.

FIG. 12 is a flowchart illustrating a security executing method for securing a DEX file according to another embodiment of the present invention.

The downloading unit 312 communicates with the program developing device 100 or the security providing device 200 via the network unit 360 to download the security app and store it in the storage unit 352.

The app installing part 314 installs the app by executing the security app stored on the storage unit 352 (S202). In this case, the encrypted machine language DEX file of the app file may be encrypted on a method-by-method basis

The replacement DEX file compiling part 316 compiles the replacement DEX file into a replacement machine language DEX file to optimize the replacement DEX file for the execution environment of the user terminal device 300 in which the replacement DEX file is to be executed (S204).

The app executing part (318) loads the replacement machine language DEX file compiled by the replacement DEX file compiling part (316) and the encrypted machine language DEX file into the memory unit (354) when the app execution is requested (S206).

The method executing part 320 includes a decryption part, which can be used to decrypt and execute predetermined methods of the encrypted machine language DEX file loaded by the app executing part 318. The method executing part 320 may execute the corresponding method of the decrypted machine language DEX file using the compiled replacement machine language DEX file when the predetermined method is invoked (S208). If the encrypted machine language DEX file is encrypted on a method-by-method basis, the method executing part 320 may, when a method is invoked, decrypt the corresponding method using the decryption part and store the method in any location of the memory unit 354, in particular, a location different from the location where the encrypted method is stored or a location where a previously decrypted method is stored.

1. A security providing method for protecting a DEX file, the method comprising the steps of:
extracting a DEX file from an app received from a program developing device;
compiling said extracted DEX file into a machine language DEX file;
protecting said compiled machine language DEX file;
generating a replacement DEX file capable of executing said protected machine language DEX file; and
packaging said protected machine language DEX file, said generated replacement DEX file, and associated ELF files into an app.

2. The security providing method according to claim 1, wherein said step of compiling comprises compiling said extracted DEX file into an OAT file by an AOT (Ahead-of-Time) compiler.

3. The security providing method according to claim 1, wherein the step of protecting comprises parsing said compiled machine language DEX file to extract methods to be encrypted and performing encryption for the extracted methods on a method-by-method basis.

4. The security providing method according to claim 1, wherein the generated replacement DEX file is filled with dummy information or proxy information in each method of the generated replacement DEX file.

5. A security executing method performed on a security executing device having an app packaged by the security providing method according to claim 1 and stored in a storage unit, the method comprises the steps of:
installing said packaged app;
when execution of said installed app is requested, loading a corresponding replacement DEX file from said storage unit into the memory unit; and
when a predetermined method is called, finding and executing the corresponding method from a protected machine language DEX file in said replacement DEX file.

6. The security executing method according to claim 5, wherein
the step of installing comprises compiling said replacement DEX file into a replacement machine language DEX file, optimized for the execution environment of said security executing device in which said app is to be executed, and
the step of loading comprises loading said compiled replacement machine language DEX file from said storage unit into said memory unit.

7. The security executing method according to claim 6, wherein the replacement machine language DEX file is compiled by the AOT (Ahead-of-Time) compiler.

8. The security executing method according to claim 6, wherein
said protected machine language DEX file of said packaged app is encrypted for each method by way of a method-by-method basis,
the step of executing comprises, when a predetermined method is first called, finding said method in said encrypted machine language DEX file in said storage unit, loading said method into said memory unit, and decrypting said method of said encrypted machine language DEX file in said memory unit.

9. The security executing method according to claim 8, wherein
the step of executing comprises decrypting the said method in said encrypted machine language DEX file, and subsequently distributing the decrypted method by storing said decrypted method in a location different from the location of the encrypted method in said memory unit.

10. The security executing method according to claim 8, wherein
said step of loading comprises building a trampoline scheme using said compiled replacement machine language DEX file and ELF file, and
said step of executing comprises, when a predetermined method is called, accessing a location of said method in said encrypted machine language DEX file by said constructed trampoline scheme.

11. The security executing method according to claim 8, wherein
the compiled replacement machine language DEX file contains proxy information for each method, and
the step of executing comprises, when the predetermined method is called, accessing the location of the method in the encrypted machine language DEX file using the proxy information for the method.

12. A security providing device for protecting a DEX file, comprising:
at least one processor configured to execute computer-readable instructions stored on the storage unit, wherein the at least one processor is configured for:
extracting a DEX file from an app received from a program developing device,
compiling said extracted DEX file into a machine language DEX file,
protecting said compiled machine language DEX file,
generating a replacement DEX file capable of executing said protected machine language DEX file, and
packaging said protected machine language DEX file, said generated replacement DEX file, and associated ELF files into an app.

13. A security providing device according to claim 12, wherein
the processor is configured to parse the compiled machine language DEX file to extract the methods to be encrypted, and to perform encryption for the extracted methods on a method-by-method basis.

14. A security providing device according to claim 13, wherein, in the said generated replacement DEX file, each method of the said replacement DEX file is filled with dummy information or proxy information.

15. A security executing device storing the app packaged by the security providing device of claim 12 in a storage unit, wherein said security executing device includes at least one processor configured to execute the computer-readable instructions stored on said storage unit, wherein said at least one processor is configured for:
installing said packaged app,
when an execution of said installed app is requested, loading a replacement DEX file from said storage unit into said memory unit; and
when a predetermined method is called, finding said method of the protected machine language DEX file in said replacement DEX file and executing it.

16. The security executing device according to claim 15, wherein
said processor is configured for
compiling said replacement DEX file into a replacement machine language DEX file adapted to the execution environment of said security executing device in which said app is to be executed, and storing said replacement machine language DEX file in said storage unit, and
when execution of said installed app is requested, loading said compiled replacement machine language DEX file from said storage unit into said memory unit.

17. The security executing device according to claim 15, wherein
said protected machine language DEX file of said packaged app is encrypted on a method-by-method basis, and,
said processor is configured for, when a predetermined method is called, locating said method of said encrypted machine language DEX file in said storage unit, loading said method into said memory unit, and decrypting said method of said encrypted machine language DEX file in said memory unit.

18. The security executing device according to claim 17, wherein said processor is configured for decrypting said method of said encrypted machine language DEX file and storing said decrypted method in a location different from the location of the encrypted method in said memory unit, thereby distributing the decrypted method.
